(19) United States
(12) Patent Application Publication
(10) Pub. No.: US 2021/0122086 A1
(43) Pub. Date: Apr. 29, 2021

(54) EXTRUSION METHOD FOR PRODUCING A THERMOPLASTIC MOLDING COMPOUND, AND DEVICE FOR CARRYING OUT THE METHOD

(71) Applicant: INEOS STYROLUTION GROUP GMBH, Frankfurt am Main (DE)

(72) Inventors: Wolfgang FISCHER, Heidelberg (DE); Peter ITTEMANN, Dannstadt-Schauernheim (DE); Tim BONGARDT, Dresden (DE); Sven SCHIPPAN, Schwarzheide (DE)

(21) Appl. No.: 17/055,272

(22) PCT Filed: May 14, 2019
(86) PCT No.: PCT/EP2019/062331

§ 371 Date: Nov. 13, 2020

(30) Foreign Application Priority Data
May 18, 2018 (EP) 18173190.2

(51) Int. Cl. B29B 9/06; B29C 48/00; B29C 48/375; B29C 48/76

(52) U.S. Cl. CPC B29B 9/065; B29C 48/0022; B29C 2793/0027; B29C 48/767; B29C 48/387

(57) ABSTRACT

Method for producing a thermoplastic molding compound (F) in an extruder, which has at least one screw having an outside diameter (D), wherein a thermoplastic component (TP) containing at least one thermoplastic polymer, a component (C) containing a graft polymer based in particular on butadiene and/or acrylate, and optionally a component (Z) containing additives are heated to a temperature of 200° C. to 280° C., melted and mixed by supplying thermal energy in a melting section (S) and/or in at least one mixing section (M) such that the thermoplastic molding compound (F) is formed, and the thermoplastic molding compound is subsequently degassed in a degassing zone (E) of the extruder, wherein an absolute pressure (P1) of less than 2 bar is set in this zone, and after the degassing the molding compound (F) is conveyed to a melt pump (SP) by screw elements, wherein the total length of the screw elements of a conveying path (FS) from the degassing opening (O) to the melt pump (SP) is less than five times the outside diameter (D) of the at least one screw.

The present invention relates to a process for the production of a thermoplastic molding composition (F) in an extruder.

In the process for the production of the thermoplastic molding composition (F) in an extruder, which has at least one screw with an external diameter (D), a thermoplastic component (TP), comprising at least one thermoplastic polymer, component (C), comprising a graft polymer based in particular on butadiene and/or on acrylate, and optionally component (Z), comprising additives, are heated by introduction of thermal energy and/or mechanical energy in a melting section (S) of the extruder and/or in at least one mixing section (M) of the extruder to a temperature of 200° C. to 280° C., melted and mixed, thus forming the thermoplastic molding composition (F), and the thermoplastic molding composition (F) is then devolatilized in a devolatilization zone (E) of the extruder, said zone having at least one devolatilization aperture (O).

The invention further relates to a thermoplastic molding composition produced by the process of the invention, and also to a device for the conduct of the process of the invention.

The production, devolatilization and optionally dewatering of thermoplastic molding compositions by means of screw-based machines is well known. Polymers and polymer blends frequently comprise residual monomers and/or residual solvents which necessitate devolatilization and which were introduced inter alia via the raw materials. In heat-sensitive polymers or polymer blends it is also possible that monomers are formed by thermally induced polymer cleavage during the extrusion process. The thermal degradation can comprise chain cleavage and/or depolymerization. Polymers that tend to depolymerize under thermal stress include polymethyl methacrylate (PMMA) and polystyrene (PS), where average degree of polymerization and the molecular mass of the polymer are decreased by cleavage of monomer from the chain end.

In the case of rubber-modified polymer blends comprising an impact modifier (rubber) based on polybutadiene, for example ABS or MABS, it is possible by way of example that the polybutadiene present is cleaved to give 1,3-butadiene. The kinetics of cleavage are generally temperature-dependent, and cleavage frequently increases at a greater rate than temperature.

Monomer content in the final product depends on the concentration of monomer in the raw materials initially used and on the efficiency of devolatilization during extrusion, but also depends on the temperature profile during the extrusion process. However, temperature during the extrusion process cannot be reduced as desired, because problems can arise with melting and mixing of the various components, and can impair product quality and in particular the mechanical properties of moldings or of other products. Low content of residual monomers in the product is in particular demanded for applications in connection with foods. There is a need for improvement here.

WO 2010/094416 describes a compounding process for the production of impact-modified thermoplastic compositions with low content of volatile organic compounds (VOC). A mixture with 2 to 40% by weight water content is mixed and melted in a compounding assembly. The compounding assembly comprises a melting zone, a mixing zone and a devolatilization zone. The devolatilized polymer melt is discharged from the compounding assembly by way of a die and, in the form of melt strand, introduced into a water bath for cooling, and pelletized. The temperature of the melt on exit from the extruder die is 280° C. or above.

WO 2017/093468 describes the production of ABS molding compositions, where the process includes the steps of precipitation of the graft copolymer, mechanical dewatering, drying of the graft copolymer and mixing with a thermoplastic copolymer, for example SAN. The process of the invention can be applied with particular success to the compositions described in WO 2017/093468.

ABS molding compositions are preferably molding compositions comprising at least 25% by weight, often at least 60% by weight, of a thermoplastic copolymer (e.g. SAN) and moreover at least one graft copolymer. ABS molding compositions preferably comprise exclusively the thermoplastic copolymer and the graft copolymer as polymeric components. An example of a commercially available ABS product is Terluran® from Ineos Styrolution (Frankfurt). The thermoplastic molding compositions for the purposes of the present invention can also be polymer blends, comprising the thermoplastic copolymer (for example SAN), a graft copolymer (for example based on a polybutadiene rubber) and comprising at least one rubber-free thermoplastic resin, for example a polycondensate, preferably selected from polycarbonates, polyester carbonates, polyesters and polyamides.

It is an object of the present invention to reduce depolymerization during the production of the thermoplastic molding composition and thus to reduce the content of residual monomers in the thermoplastic molding composition in the extrusion process, in particular after the devolatilization zone (E).

Surprisingly, it has been found that longer regions of conveying (FS) with conveying elements after the devolatilization aperture (O) of the devolatilization zone (E) in an extruder lead to a significant increase of the temperature of the molding composition (F), and also specifically when the pressure increase needed for pelletization is achieved by using a melt pump. This temperature increase can, as described, lead to an undesirably large increase of the quantity of residual monomers in the molding composition (F).

The object is achieved via a process for the production of a thermoplastic molding composition (F) in an extruder, which has at least one screw with an external diameter (D), where:
the thermoplastic component (TP), comprising at least one thermoplastic polymer, e.g. SAN copolymer,
component (C), comprising a graft polymer based in particular on butadiene and/or on acrylate, examples being ASA copolymers or ABS copolymers, and
optionally component (Z), comprising additives,
   are heated by introduction of thermal energy and/or mechanical energy in a melting section (S) of the extruder and/or in at least one mixing section (M) of the extruder to a temperature of 200° C. to 280° C., melted and mixed, thus forming the thermoplastic molding composition (F),
and the thermoplastic molding composition (F) is then devolatilized in a devolatilization zone (E) of the extruder, said zone having at least one devolatilization aperture (O), where an absolute pressure (P1) below 2 bar, preferably below 1.5 bar and more preferably below 1 bar, is established in the devolatilization zone (E) of the extruder, and
after the devolatilization, the thermoplastic molding composition (F) is conveyed by means of screw elements to a melt pump (SP), where the total length of the screw elements of a region of conveying (FS) from the at least one devolatilization aperture (O) to the melt pump (SP) is less than five times, preferably less than four times, the external diameter (D) of the screw. The expression “region of conveying” (FS) means the region between the downstream end of the devolatilization aperture (O) and the end of the final screw element (see figures).

The invention further relates to a device for the conduct of the process of the invention, comprising an extruder, which comprises at least one screw with an external diameter (D), an addition section (DA), at least one mixing section (M) and at least one devolatilization zone (E) and a melt pump (SP) with an entry aperture, where the devolatilization zone (E) has at least one devolatilization aperture (O) and the arrangement of the devolatilization zone (E) and the melt pump (SP) is such that the total length of the screw elements of the region of conveying (FS) between the at least one devolatilization aperture (O) of the devolatilization zone (E) and the entry aperture of the melt pump (SP) is less than five times, preferably less than four times, the external diameter (D) of the screw.

The invention further relates to a thermoplastic molding composition (F) produced by the process of the invention, for example an ABS or ASA molding composition.

The process of the invention, which can also be termed compounding, the device of the invention and the thermoplastic molding composition (F) of the invention are described below.

In an extruder, the drive power is converted to temperature increase and pressurization. An extruder usually comprises the following process zones: solids intake, melting (plastification), possibly further materials intake, dispersion, homogenization, devolatilization and discharge (see also “Aufbereiten von Polyolefinen [Compounding of polyolefins]”, VDI-Verlag, 1984, pp. 185ff). The present invention is in particular directed to the process zone where the polymer composition is discharged.

The extruder is preferably composed of the following, in downstream conveying direction:

a) at least one addition section (DA), into which the thermoplastic component (TP) is at least to some extent introduced by means of addition equipment,

b) at least one melting section (S), in which at least portions of the thermoplastic component (TP) and optionally component C are melted,

c) at least one mixing section (M), which comprises mixing elements, kneading elements and/or other plastifying elements,

d) at least one devolatilization zone (E), which has at least one devolatilization aperture (O), and

e) a discharge zone (AZ), in which the thermoplastic molding composition (F) is discharged from the extruder.

In the at least one addition section (DA), solid is usually conveyed and compacted, and entrained air is also removed. In the at least one melting section (S), polymers are usually melted and fillers are usually predispersed. This can be followed by a melt-conveying zone, for example a distributive mixing zone, in which solids and fluids are distributed in the melt and the temperature of the composition is homogenized. In a dispersive mixing zone is it possible to disperse solid polymer particles and liquid droplets. The devolatilization zone (E) serves in particular for the removal of water, residual monomers and solvents. In particular, air, water and/or volatile organic compounds (VOC) escape through the at least one devolatilization aperture (O).

In principle, high melt temperature, high rotation rate and optionally addition of entrainer (e.g. water), and also application of a vacuum, serve to optimize devolatilization. The at least one devolatilization aperture (O) preferably has a suction-removal system utilizing the Venturi effect. It is preferable that the at least one devolatilization aperture (O) is equipped with a retention screw. Retention screws, also known as stuffing screws, can prevent the escape of the thermoplastic molding composition (F) through the at least one devolatilization aperture (O). Other retention elements can also be used.

The at least one devolatilization aperture (O) can be operated under atmospheric pressure, under vacuum or under superatmospheric pressure, and it is possible here that all devolatilization apertures (O) have the same or different pressure. In the case of a vacuum, the absolute pressure (P1) in the devolatilization zone (E) is usually 2 mbar to 900 mbar, preferably 10 mbar to 800 mbar, particularly preferably 30 mbar to 500 mbar. In the case of devolatilization under superatmospheric pressure, the absolute pressure established is generally 1.1 bar to 1.5 bar. However, it is preferable to operate the at least one devolatilization aperture (O) under atmospheric pressure or under vacuum.

The discharge zone (AZ) usually comprises a pressure-increase zone, in order to generate the pressure needed in downstream assemblies such as filters.

The extruder can moreover comprise a further input section, in which some or all of at least one of the components (TP), (C) and (Z) is introduced, preferably in the form of melt, downstream of the addition section (DA) in conveying direction. The at least one melting section (S) and at least one mixing section (M) can be combined in a section of the extruder.

In a preferred embodiment, the external diameter (D) of the at least one screw is 30 mm to 230 mm, in particular 60 mm to 220 mm. A preferred rate of rotation of the at least one screw is 200 to 1500 rpm. The extruder preferably has two screws, in particular two screws rotating in the same direction. The throughput of thermoplastic molding composition (F) in the extruder is preferably 400 kg/h to 10 000 kg/h.

The absolute pressure (P2) of the thermoplastic molding composition (F) during conveying in the region of conveying (FS) from the at least one devolatilization aperture (O) to the melt pump (SP) is preferably below 40 bar, more preferably below 30 bar and in particular below 15 bar.

The absolute pressure (P3) of the thermoplastic molding composition (F) is increased in the melt pump (SP), preferably to at least 50 bar, more preferably to at least 65 bar and with particular preference to at least 70 bar.

The absolute pressure can be measured in each case by conventional pressure-measurement equipment. The method of checking can be based on direct measurement of the mechanical pressure or on measurement of the pressure on a membrane, a piezo element, a sensor, or other conventional components that are used by the person skilled in the art for checking pressure in technical systems.

The temperature of the molding composition (F) can be measured via a thermometer extending into the melt to a substantial depth within an adapter (AD), and/or by using a commercially available insertion thermometer on the polymer strand, i.e. at the die or at the start-up diverter of the underwater pelletization equipment when said diverter has been switched to “floor”.

In contrast to a further extruder section in which conveyor elements are used to increase pressure, the melt pump (SP) which serves for pressure increase and for discharge of the thermoplastic molding composition (F) from the extruder has the advantage that the thermoplastic molding composition (F) is conveyed without any great additional temperature increase. The melt pump (SP) is preferably configured as gear pump.

During conveying from the at least one devolatilization aperture (O) to the melt pump (SP), the temperature of the thermoplastic molding composition (F) is preferably below 280° C. The temperature is preferably below 275° C. and in particular below 265° C.

The temperature of the thermoplastic molding composition (F) after the melting section (S) in conveying direction is usually at least 200° C.

The thermoplastic molding composition (F) can be conveyed from the at least one devolatilization aperture (O) to the melt pump (SP) by way of at least one screw element and/ or by way of adapter. The adapter comprises no conveying elements and no mixing elements, and therefore the temperature of the thermoplastic molding composition (F) is in essence constant over the length of the adapter. The adapter serves merely for the transfer of the thermoplastic molding composition (F) from the devolatilization zone (E) into the melt pump (SP), these usually having different aperture geometries. For the purposes of the invention, the melt pump (SP) optionally comprises the adapter.

It is preferable that there are no mixing elements arranged between the devolatilization zone (E) and the melt pump (SP). It is moreover preferable that there is no continuous barrel section arranged between the barrel section of the devolatilization zone (E) and the melt pump (SP). It is preferable that the melt pump (SP) replaces continuous barrel sections with conveying elements arranged after the devolatilization zone (E) in conveying direction.

The distance between the at least one devolatilization aperture (O) and the melt pump (SP) is reduced in order to reduce or avoid further heating of the thermoplastic molding composition (F) after devolatilization, thus minimizing the formation of monomers or degradation products by depolymerization. The content of degradation products, and/or of residual monomers, for example monomeric butadiene and/or monomeric acrylate, can serve as measure for non-aggressive processing of the thermoplastic molding composition (F).

The thermoplastic molding composition (F) can be introduced, from the melt pump (SP), into a melt-pelletization procedure, in particular an underwater pelletization procedure. Appropriate devices are known. It is preferable that the thermoplastic molding composition (F) emerging from a pelletizing die or other die attached after the melt pump (SP) is cooled, whereupon the thermoplastic molding composition (F) solidifies, and is optionally pelletized.

The thermoplastic molding composition (F) can moreover be conveyed via at least one melt filter (SF) after the melt pump (SP) in conveying direction. These filters are known to the person skilled in the art. The at least one melt filter (SF) can also be configured as melt sieve.

It is preferable that there is at least one melt filter arranged after the melt pump (SP) in conveying direction. It is preferable that the melt pump (SP) has connection to a device for the underwater pelletization procedure (UW).

The thermoplastic component (TP) preferably comprises a component (A), comprising a thermoplastic polymer, and a component (B), comprising a styrene copolymer. In particular, the thermoplastic component (TP) consists of component (A) and component (B).

It is preferable that component (A) comprises a polymethyl methacrylate (PMMA), a polyamide and/or a polycarbonate (PC) or consists of polymethyl methacrylate (PMMA), polyamide and/or polycarbonate (PC). Component (B) often comprises (or is) a styrene-acrylonitrile copolymer (SAN) or an a-methylstyrene-acrylonitrile copolymer (AMSAN). Component (C) often comprises a butadiene-containing rubber or is a butadiene-containing rubber.

The process is suitable for the production of products such as Terluran® (ABS from Ineos Styrolution, Frankfurt) or Terlux® (MABS from Ineos Styrolution, Frankfurt).

It is preferable that the thermoplastic molding composition (F) comprises, based in each case on the entirety of components (A), (B) and (C), 25 to 69% by weight of component (A), 30 to 69% by weight of component (B), 1 to 40% by weight of component (C) and moreover 0 to 20% by weight, often 0.1 to 10% by weight, of component (Z).

Component (A) here often consists of a polymethyl methacrylate (PMMA), a polyamide (PA) and/or a polycarbonate (PC), component (B) here often consists of a styrene-acrylonitrile copolymer (SAN) and/or of an a-methylstyrene-acrylonitrile copolymer (AMSAN), and component (C) here often consists of a butadiene-containing rubber, and component (Z) here often consists of one or more additives.

It is further preferable that component (A) comprises a polymethyl methacrylate (PMMA), a polyamide (PA) or a polycarbonate (PC), that component (B) comprises a styrene-acrylonitrile copolymer (SAN), and that component (C) comprises a butadiene-containing rubber.

The use of elastomeric graft copolymers where the graft core consists of comparatively large agglomerated particles obtainable via addition of an agglomeration polymer during production of the graft cores is known for improving the mechanical properties of thermoplastic molding compositions.

It is preferable that the thermoplastic molding composition (F) is based on hard methyl methacrylate polymers, hard vinylaromatic-vinyl cyanide polymers and “soft” graft copolymers which, while substantially retaining good mechanical properties, moreover exhibit improved optical properties, in particular a low level of light scattering.

With particular preference, the thermoplastic molding composition (F) comprises a first mixture of:
component (A)
25 to 69% by weight, based on the entirety of components (A), (B) and (C), of a methyl methacrylate polymer obtainable by polymerization of a second mixture consisting of
(A1) 90 to 100% by weight, based on (A), of methyl methacrylate, and
(A2) 0 to 10% by weight, based on (A), of a C₁-C₈-alkyl ester of acrylic acid, and
component (B)
30 to 69% by weight, based on the entirety of components (A), (B) and (C), of a copolymer obtainable by polymerization of a third mixture of
(B1) 65 to 88% by weight, based on (B), of a vinylaromatic monomer and
(B2) 12 to 35% by weight, based on (B), of a vinyl cyanide, and component (C)
1 to 40% by weight, often 10 to 40% by weight, based on the entirety of components (A), (B) and (C), of a graft copolymer obtainable from:
(C1) 40 to 90% by weight, based on (C), of a core obtainable by polymerization of a first monomer mixture consisting of
   (C11) 65 to 99.9% by weight, based on (C1), of a 1,3-diene,
   (C12) 0 to 34.9% by weight, based on (C1), of vinylaromatic monomers,
   (C13) 0.1 to 5% by weight, based on (C1), of an agglomeration polymer, and
(C2) 5 to 40% by weight, based on (C), of a first graft shell obtainable by polymerization of a second monomer mixture consisting of
   (C21) 30 to 39% by weight, based on (C2), of a vinylaromatic monomer
   (C22) 61 to 70% by weight, based on (C2), of a C₁-C₈-alkyl ester of methacrylic acid and
   (C23) 0 to 3% by weight, based on (C2), of a crosslinking monomer, and
(C3) 5 to 40% by weight, based on (C), of a second graft shell obtainable by polymerization of a third monomer mixture consisting of
   (C31) 70 to 98% by weight, based on (C3), of a C₁-C₈-alkyl ester of methacrylic acid and
   (C32) 2 to 30% by weight, based on (C3), of a C₁-C₈-alkyl ester of acrylic acid, and
   optionally component (Z), comprising additives, in quantities of 0 to 20% by weight, frequently of 0.1 to 10% by weight, based on the entirety of components (A), (B) and (C),
   with the proviso that the ratio by weight of (C2) to (C3) is further preferably in the range of 2:1 to 1:2, where
   the core (C1) has a monomodal particle size distribution,
   the median particle size D₅₀ of the core (C1) is in the range of 300 to 400 nm and
   the absolute value of the difference calculated from refractive index (n_{D}-C) of the entire component (C) and the refractive index (n_{D}-AB) of an entire matrix of components (A) and (B) is below 0.01.

In particular, the thermoplastic molding composition (F) consists of the first mixture.

In a preferred embodiment, the thermoplastic molding composition (F) that can be produced by the process is characterized in that it comprises (or consists of) (based in each case on the entirety of components (A), (B) and (C)):

A) 25 to 69% by weight of polymethyl methacrylate,

B) 30 to 69% by weight of styrene-acrylonitrile copolymer,

C) 10 to 40% by weight of butadiene-methyl methacrylate-styrene-graft rubber

Z) 0.1 to 10% by weight of additives.

In a preferred embodiment, the thermoplastic molding composition (F) is characterized in that the absolute value of the difference calculated from refractive index (n_{D}-C) of the entire component (C) and the refractive index (n_{D}-AB) of an entire matrix of components (A) and (B) is below 0.01, and in particular in the range 0.003 to 0.008.

The refractive indices (n_{D}-C) and (n_{D}-AB) can be measured on films pre-pressed from the respective polymers (C) or polymer mixtures of components (A) and (B) in an IWK press at 200° C. and at a pressure of 3 to 5 bar for 2 min and finally further pressed for 3 min at 200° C. and 200 bar. The measurements can be made at 20° C. with an Abbe refractometer by the method for measuring refractive indices for solid bodies (see Ullmanns Enzyklopadie der technischen Chemie, Band 2/1 [Ullmanns Encyclopedia of Industrial Chemistry, vol. 2/1], p. 486, ed. E. Foerst; Munich-Berlin 1961). The particles sizes are determined by familiar methods.

The methyl methacrylate polymer preferably used is preferably either a homopolymer of methyl methacrylate ora copolymer of MMA with up to 10% by weight, based on (A), of a C₁-C₈-alkyl ester of acrylic acid.

The following can be used as C₁-C₈-alkyl ester of acrylic acid (component A2): methyl acrylate, ethyl acrylate, propyl acrylate, n-butyl acrylate, n-pentyl acrylate, n-hexyl acrylate, n-heptyl acrylate, n-octyl acrylate and 2-ethylhexyl acrylate, and also mixtures thereof, preferably methyl acrylate, ethyl acrylate, n-butyl acrylate, 2-ethylhexyl acrylate or a mixture thereof, particularly preferably methyl acrylate. The methyl methacrylate (MMA) polymers can be produced by bulk polymerization, solution polymerization or bead polymerization by known methods (see by way of example Kunststoff-Handbuch, Band IX, “Polymethacrylate” [Plastics handbook, vol. IX, “Polymethacrylates”], Vieweg/Esser, Carl-Hanser-Verlag 1975) and are obtainable commercially.

Component (B) is preferably a copolymer of a vinylaromatic monomer (B1) and vinyl cyanide (B2).

The following can be used as vinylaromatic monomers (component B1): styrene, styrene mono- to trisubstituted by C₁-C₈-alkyl moieties, for example p-methylstyrene or tert-butylstyrene, or else α-methylstyrene, preferably styrene.

The following can be used as vinyl cyanide (component B2): acrylonitrile and/or methacrylonitrile, preferably acrylonitrile.

The copolymers (B) can be produced by known processes, such as by bulk polymerization, solution polymerization, suspension polymerization or emulsion polymerization, preferably by solution polymerization (see GB-A 14 72 195).

It is preferable to use, as component (C), a graft copolymer made of a core (C1) and of two graft shells (C2) and (C3) applied thereto.

The core (C1) is preferably the graft base. Butadiene and/or isoprene can be used as 1,3-diene (component C11) of the core of the graft copolymer (component C1).

The following can be used as vinylaromatic monomer (component C12): styrene, or preferably styrene substituted on the ring by one C₁-C₈-alkyl group, preferably methyl, preferably in α-position, or else by a plurality of C₁-C₈-alkyl groups, preferably methyl.

The following can be used as agglomeration polymer (component C13): components that are known and by way of example described in WO 01/83574, WO 02/10222 or DE-A 24 27 960.

The following are suitable by way of example as agglomeration polymers: dispersions of acrylic ester polymers, preferably of copolymers of ethyl acrylate and methacrylamide, where the proportion of methacrylamide in these is 0.1 to 20% by weight, based on the copolymer. The concentration of the acrylic ester polymers in the dispersion is preferably 3 to 40% by weight, particularly preferably 5 to 20% by weight.

The core (C1) is preferably produced in two stages by processes that are known to the person skilled in the art and are described by way of example in Encyclopedia of Polymer Science and Engineering, vol. 1, pp. 401 ff. The usual method uses, in the first stage, components (C11) and (C12) to produce a core by processes known to the person skilled in the art, for example emulsion polymerization, (see Encyclopedia of Polymer Science and Engineering, vol. 1, pp. 401 ff), the glass transition temperature of which is preferably lower than 0° C., and the median particle size D₅₀ of which is generally in the range of 30 to 240 nm, preferably in the range of 50 to 180 nm.

In a second stage, processes known to the person skilled in the art and described by way of example in Encyclopedia of Polymer Science and Engineering, vol. 1, pp. 401 ff.

are used to react the core obtained in the first stage with the agglomeration polymer (C13), whereupon the core (C1) is obtained with a median particle size D₅₀ in the range of 300 to 400 nm, preferably 320 to 380 nm, particularly preferably 340 to 360 nm. It is preferable that the core (C1) has a monomodal particle size distribution.

The graft shell (C2) which comprises the monomers (C21), (C22) and optionally (C23) is preferably applied to the core (C1).

The following can be used as vinylaromatic monomer (component C21): styrene, or preferably styrene substituted on the ring by one C₁-C₈-alkyl group, preferably methyl, preferably in α-position, or else by a plurality of C₁-C₈-alkyl groups, preferably methyl.

The following are preferably used as C₁-C₈-alkyl ester of methacrylic acid (component C22): methyl methacrylate (MMA), ethyl methacrylate, n-propyl methacrylate, isopropyl methacrylate, n-butyl methacrylate, isobutyl methacrylate, sec-butyl methacrylate, tert-butyl methacrylate, pentyl methacrylate, hexyl methacrylate, heptyl methacrylate, octyl methacrylate or 2-ethylhexyl methacrylate, particular preference being given here to methyl methacrylate, or else a mixture of these monomers.

The following can be used as monomers (C23): conventional crosslinking monomers, i.e. in essence di- or polyfunctional comonomers, in particular alkylene glycol di(meth)acrylates such as ethylene glycol di(meth)acrylate, propylene glycol di(meth)acrylate and butylene glycol di(meth)acrylate, allyl methacrylate, (meth)acrylates of glycerol, trimethylolpropane, pentaerythritol, or vinylbenzenes such as di- or trivinylbenzene. Preference is given to use of butylene glycol dimethacrylate, butylene glycol diacrylate and dihydrodicyclopentadienyl acrylate in the form of an isomer mixture, and particular preference is given to use of dihydrodicyclopentadienyl acrylate in the form of an isomer mixture.

It is preferable that a further graft shell (C3), which comprises the monomers (C31) and (C32), is applied to the graft shell (C2) in turn. The monomers (C31) are C₁-C₈-alkyl esters of methacrylic acid, and the monomers (C32) are C₁-C₈-alkyl esters of acrylic acid.

The following are preferably used as C₁-C₈-alkyl esters of methacrylic acid (monomers C31): methyl methacrylate (MMA), ethyl methacrylate, n-propyl methacrylate, isopropyl methacrylate, n-butyl methacrylate, isobutyl methacrylate, sec-butyl methacrylate, tert-butyl methacrylate, pentyl methacrylate, hexyl methacrylate, heptyl methacrylate, octyl methacrylate or 2-ethylhexyl methacrylate, particular preference being given here to methyl methacrylate, or else a mixture of these monomers.

The following can be used as C₁-C₈-alkyl esters of acrylic acid (monomers C32): methyl acrylate (MA), ethyl acrylate, propyl acrylate, n-butyl acrylate, isobutyl acrylate, sec-butyl acrylate, tert-butyl acrylate, pentyl acrylate, hexyl acrylate, heptyl acrylate, octyl acrylate or 2-ethylhexyl acrylate, particular preference being given here to methyl acrylate, or else a mixture of these monomers with one another.

The two graft shells (C2) and (C3) are preferably produced in the presence of the core (C1) by methods known from the literature, in particular by emulsion polymerization (Encyclopedia of Polymer Science and Engineering, vol. 1, page 401 ff.). Use of what is known as the seed procedure here avoids formation of any new particles during production of the two graft shells. The seed procedure moreover allows determination of the number and the nature of the particles in both graft stages via the quantity and the nature of the emulsifier used. The emulsion polymerization is usually initiated by polymerization initiators. Ionic and non-ionic emulsifiers can be used during the emulsion polymerization.

Examples of suitable emulsifiers are sodium dioctyl sulfosuccinate, sodium lauryl sulfate, sodium dodecylbenzenesulfonate, alkylphenoxypolyethylenesulfonates and salts of long-chain carboxylic acids and of long-chain sulfonic acids. The following are suitable by way of example as non-ionic emulsifiers: fatty alcohol polyglycol ethers, alkylarylpolyglycol ethers, fatty acid monoethanolamides, and also ethoxylated fatty acid amides and ethoxylated fatty acid amines. The total quantity of emulsifier, based on the total weight of the emulsion graft copolymer, is preferably 0.05 to 5% by weight.

The following can be used as polymerization initiators: ammonium peroxodisulfates and alkali metal peroxodisulfates, for example potassium peroxodisulfate, and also combined initiator systems such as sodium persulfate, sodium hydrosulfite, potassium persulfate, sodium formaldehydesulfoxylate and potassium peroxodisulfate, sodium dithionite-iron(II) sulfate, and the polymerization temperatures here in the case of the ammonium peroxodisulfates and alkali metal peroxodisulfates, which require thermal activation, can be 50 to 100° C., and in the case of the initiator combinations which act as redox systems can be lower, for example in the range of 20 to 50° C.

The total quantity of initiator is preferably between 0.02 and 1.0% by weight, based on the finished emulsion polymer.

It is moreover possible to use polymerization regulators both in the production of the base, i.e. of the core (C1) and also in the production of the two graft stages, i.e. the two graft shells (C2) and (C3). Alkyl mercaptans, for example n- or tert-dodecyl mercaptan, are used inter alia as polymerization regulators. The quantity usually used of the polymerization regulators is 0.01 to 1.0% by weight, based on the respective stage.

In other respects, production of the emulsion graft copolymer is preferably such that an aqueous mixture, consisting of monomers, crosslinking agent, emulsifier, initiator, regulator and a buffer system is charged to a nitrogen-inertized reactor, and is inertized at low temperature, with stirring, and then is brought to the polymerization temperature in the course of 15 to 120 minutes. Polymerization is then carried out as far as a conversion of at least 95%. Monomers, crosslinking agent, emulsifier, initiator and regulator can also be introduced entirely or to some extent as feed into the aqueous charge. The stages (C2) and (C3) are optionally produced after a post-reaction time of 15 to 120 minutes with feed of the monomers in the presence of the previously formed stage (C1) by emulsion polymerization.

From the resultant latex, preferably occurs in a known manner via precipitation, filtration and subsequent drying.

For the precipitation, it is possible to use by way of example aqueous solutions of inorganic salts such as sodium chloride, sodium sulfate, magnesium sulfate and calcium chloride, aqueous solutions of salts of formic acid, for example magnesium formate, calcium formate and zinc formate, aqueous solutions of inorganic acids such as sulfuric acid and phosphoric acid, and also aqueous ammoniacal and aminic solutions, and also other aqueous alkaline solutions, e.g. of sodium hydroxide and potassium hydroxide. However, the precipitation can also be achieved by physical methods, for example freeze precipitation, shear precipitation or steam precipitation. The drying can by way of example be achieved by freeze drying, spray drying, fluidized-bed drying and convective drying. It is also possible that the precipitated emulsion graft copolymer is further processed without drying.

Conventional additives (Z) that can be used are any of such substances that have good solubility in components (TP) and (C), or have good miscibility therewith. Suitable additives are inter alia dyes, stabilizers, lubricants and antistatic agents.

It is preferable that the thermoplastic molding composition (F) comprises no more than 5% by weight, in particular no more than 1% by weight, of water, based on the entire composition of the thermoplastic molding composition (F), the water content here being determined after the melting section (S) and after the at least one mixing section (M) and before the at least one devolatilization aperture (O).

The thermoplastic molding composition (F) comprises, in particular after conduct of the process of the invention, no more than 5 ppm, often no more than 3 ppm, in particular no more than 1 ppm, of residual monomer, in particular monomeric butadiene, based on the entire composition of the thermoplastic molding composition (F).

The thermoplastic molding composition (F) can be used to produce moldings, primarily by injection molding or by blow molding. Further, the thermoplastic molding compositions (F) can also be pressed, calendered, extruded or vacuum-formed. Comparative examples and inventive examples of the invention are presented in the drawings and are explained in more detail in the description below and in the claims.

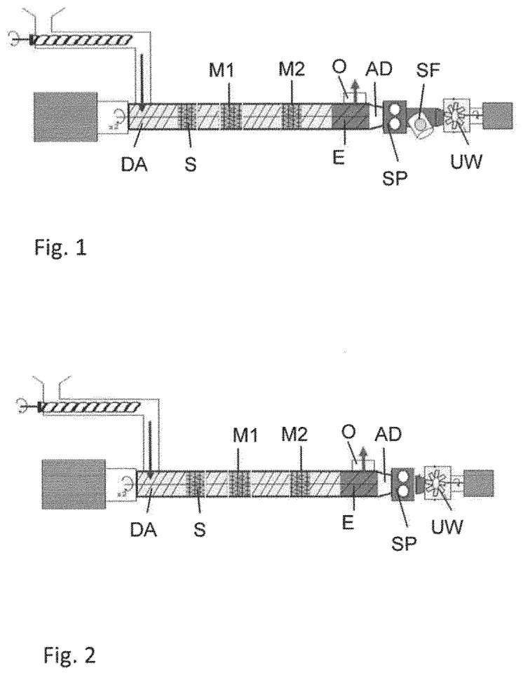

FIG. 1 shows an extruder of the invention with melt filter,

FIG. 2 shows an extruder of the invention without melt filter,

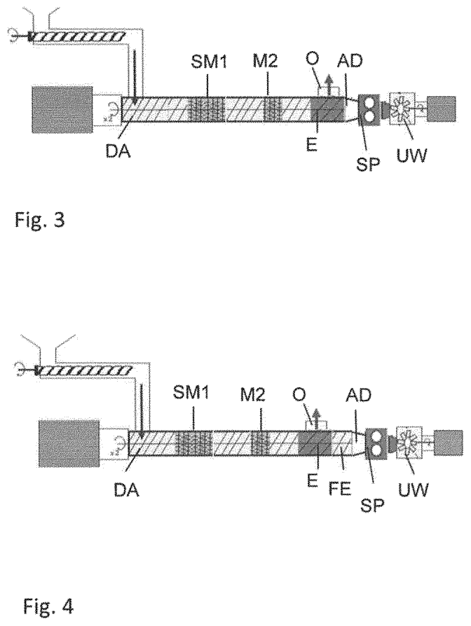

FIG. 3 shows an extruder of the invention with combined melting and mixing zone,

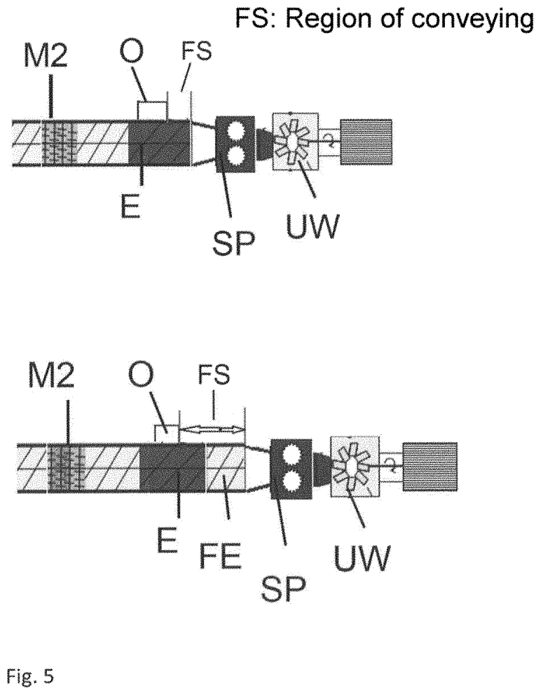

FIG. 4 shows an extruder with combined melting and mixing zone according to the prior art and

FIG. 5 shows an embodiment of an extruder without further conveying elements (FE) and an embodiment with further conveying elements (FE).

FIG. 1 shows an extruder of the invention comprising an addition section (DA), a melting section (S), a first mixing section (M1), a second mixing section (M2) and a devolatilization zone (E) with a devolatilization aperture (O), and also a melt pump (SP), which has an adapter (AD). There is a melt filter (SF) arranged after the melt pump (SP) in conveying direction, followed by a device for the underwater pelletization procedure (UW).

FIG. 2 shows an extruder of the invention which in essence corresponds to the extruder depicted in FIG. 1, but has no melt filter (SF).

FIG. 3 shows an extruder of the invention which in essence corresponds to the extruder depicted in FIG. 2. The melting section and a mixing section are combined here in one section (SM1).

FIG. 4 shows an extruder according to the prior art which, in contrast to the extruder depicted in FIG. 3, has further conveying elements (FE) between the devolatilization zone (E) and the melt pump (SP), and therefore the length of the region of conveying (FS) between the devolatilization aperture (O) and the melt pump (SP), where this means the total length of the screw elements of the region of conveying (FS), is more than five times the external diameter of the extruder screw.

FIG. 5 shows, in the upper image, an extruder of the invention which, in contrast to the extruder depicted in the lower image, has no further conveyor elements (FE) between the devolatilization zone (E) and the melt pump (SP). Accordingly, according to the upper image there is a short region of conveying (FS) present, in contrast to the region of conveying (FS) according to the lower image of FIG. 5.

### COMPARATIVE EXAMPLE 1

500 kg/h of thermoplastic molding composition were produced at a rotation rate of 500 rpm in an extruder which had two screws rotating in the same direction with an external diameter (D) of 65 mm, a devolatilization section, comprising a devolatilization aperture (O), and a discharge zone following same. This was an extruder analogous to the lower image of FIG. 5, but without a melt pump (SP).

The thermoplastic molding composition (TP) in the examples consisted of:
A) 28.60% by weight of polymethyl methacrylate, VN 53 ml/g (0.5% by weight in DMF at 25° C.),
B) 35.10% by weight of styrene-acrylonitrile copolymer, VN 100 ml/g (0.5% by weight in DMF at 25° C.), comprising 81% by weight of styrene, 19% by weight of acrylonitrile,
C) 36.10% by weight of butadiene-methyl methacrylate-styrene-graft rubber (MBS product Paraloid 2668 from Dow Chemical), and also
Z) 0.20% by weight of calcium stearate.

The discharge zone, in which the pressure was increased to 60 bar, comprised conveying elements. The extruder comprised no melt pump (SP), and the length of the region of conveying FS between the devolatilization aperture O and the melt pump SP was 5.25 D.

The temperature of the thermoplastic molding composition measured by a commercially available insertion thermometer on the pellet strand discharged from the start-up diverter of the underwater pelletization system, which had been switched to “floor”, was 295° C. at the end of the discharge zone. Content of residual monomers was determined by means of gas chromatography, where the sample was produced by placing 1 g of the fully cooled resultant thermoplastic molding composition in 5 g of a solvent mixture produced from 78.048 g of dimethyl sulfoxide, 7.2 mg of mesitylene, 4.32 g of toluene and 0.432 g of propionitrile and shaking at 40° C. for 24 hours. A liquid sample of the mixture cooled to room temperature was injected into a gas chromatograph.

The content of residual butadiene determined in the thermoplastic molding composition produced was 5.5 ppm, based on the entire composition of the thermoplastic molding composition. This is disadvantageous for some applications.

### COMPARATIVE EXAMPLE 2

The extruder used in comparative example 2, based on FIG. 4, differed from the extruder according to comparative example 1 in that the pressure was increased from 10 bar to 60 bar by a melt pump following the discharge zone. The length of the region of conveying (FS) between the devolatilization aperture (O) and the melt pump (SP) was 5.25 D. The temperature of the thermoplastic molding composition after the melt pump was 285° C. The residual butadiene content determined in the resultant thermoplastic molding composition was 3.5 ppm, based on the entire composition of the thermoplastic molding composition. This is disadvantageous for some applications.

### INVENTIVE EXAMPLE 3

The extruder used, corresponding to FIG. 3, differed from the extruder according to comparative example 2 in that the length of the region of conveying (FS) between the devolatilization aperture (O) and the melt pump (SP) was only 1.25 D.

The temperature of the thermoplastic molding composition after the melt pump was 256° C. The residual butadiene content determined in the resultant thermoplastic molding composition was below 1 ppm, based on the entire composition of the thermoplastic molding composition.

The effect of the low level of build-up of residual monomer with the process of the invention could also be confirmed with other styrene-copolymer molding compositions comprising graft polymer, for example the ABS compositions according to WO 2017/093468 (e.g. with molding compositions comprising at least 60% by weight of SAN and at least one polybutadiene-based graft copolymer).

1-16. (canceled)

17. A process for the production of a thermoplastic molding composition (F) in an extruder, which has at least one screw with an external diameter (D),
where a thermoplastic component (TP), comprising at least one thermoplastic polymer, component (C), comprising a graft polymer based on butadiene and/or on acrylate, and optionally component (Z), comprising additives, are heated by introduction of thermal energy and/or mechanical energy in a melting section (S) of the extruder and/or in at least one mixing section (M) of the extruder to a temperature of 200° C. to 280° C., melted, and mixed, thus forming the thermoplastic molding composition (F), and
the thermoplastic molding composition (F) is then devolatilized in a devolatilization zone (E) of the extruder, said zone having at least one devolatilization aperture (O), where an absolute pressure (P1) below 2 bar is established in the devolatilization zone (E) of the extruder, and
after the devolatilization, the thermoplastic molding composition (F) is conveyed by means of screw elements to a melt pump (SP), where the total length of the screw elements of a region of conveying (FS) from the at least one devolatilization aperture (O) to the melt pump (SP) is less than five times the external diameter (D) of the at least one screw.

18. The process of claim 17, wherein the absolute pressure (P2) of the thermoplastic molding composition (F) during conveying from the at least one devolatilization aperture (O) to the melt pump (SP) is below 40 bar.

19. The process of claim 17, wherein the absolute pressure (P3) of the thermoplastic molding composition (F) is increased in the melt pump (SP) to at least 50 bar.

20. The process of claim 17, wherein the temperature of the thermoplastic molding composition (F) during conveying from the at least one devolatilization aperture (O) to the melt pump (SP) is below 280° C.

21. The process of claim 17, wherein the thermoplastic molding composition (F) is introduced, from the melt pump (SP), into a melt-pelletization procedure.

22. The process of claim 17, wherein the thermoplastic molding composition (F) is conveyed via at least one melt filter (SF) after the melt pump (SP) in conveying direction.

23. The process of claim 17, wherein the thermoplastic component (TP) comprises a component (A), comprising a thermoplastic polymer, and a component (B), comprising a styrene copolymer.

24. The process of claim 17, wherein the thermoplastic component (TP) comprises, as a component (A), a polymethyl methacrylate (PMMA), a polyamide, and/or a polycarbonate (PC), and comprises, as a component (B), a styrene-acrylonitrile copolymer (SAN) or an alpha-methyl-styrene-acrylonitrile copolymer (AMSAN), and comprises, as the component (C), a butadiene-containing graft rubber.

25. The process of claim 17, wherein the thermoplastic molding composition (F) comprises a first mixture of:
component (A):
25 to 69% by weight, based on the entirety of components (A), (B), and (C), of a methyl methacrylate polymer obtainable by polymerization of a second mixture consisting of:
(A1) 90 to 100% by weight, based on (A), of methyl methacrylate, and
(A2) 0 to 10% by weight, based on (A), of a C₁-C₈-alkyl ester of acrylic acid, component (B):
30 to 69% by weight, based on the entirety of components (A), (B), and (C), of a copolymer obtainable by polymerization of a third mixture of:
(B1) 65 to 88% by weight, based on (B), of a vinylaromatic monomer, and
(B2) 12 to 35% by weight, based on (B), of a vinyl cyanide,
component (C):
1 to 40% by weight, based on the entirety of components (A), (B), and (C), of a graft copolymer obtainable from:
(C1) 40 to 90% by weight, based on (C), of a core obtainable by polymerization of a first monomer mixture consisting of:
(C11) 65 to 99.9% by weight, based on (C1), of a 1,3-diene,
(C12) 0 to 34.9% by weight, based on (C1), of vinylaromatic monomers, and
(C13) 0.1 to 5% by weight, based on (C1), of an agglomeration polymer,
(C2) 5 to 40% by weight, based on (C), of a first graft shell obtainable by polymerization of a second monomer mixture consisting of:
(C21) 30 to 39% by weight, based on (C2), of a vinylaromatic monomer,
(C22) 61 to 70% by weight, based on (C2), of a C₁-C₈-alkyl ester of methacrylic acid, and
(C23) 0 to 3% by weight, based on (C2), of a crosslinking monomer,
and
(C3) 5 to 40% by weight, based on (C), of a second graft shell obtainable by polymerization of a third monomer mixture consisting of:
(C31) 70 to 98% by weight, based on (C3), of a C₁-C₈-alkyl ester of methacrylic acid, and
(C32) 2 to 30% by weight, based on (C3), of a C₁-C₈-alkyl ester of acrylic acid,
and
optionally component (Z), comprising additives, in quantities of 0 to 20% by weight, based on the entirety of components (A), (B), and (C),
with the proviso that the ratio by weight of (C2) to (C3) is in the range of 2:1 to 1:2, where:
the core (C1) has a monomodal particle size distribution,
the median particle size D₅₀ of the core (C1) is in the range of 300 to 400 nm, and
the absolute value of the difference calculated from refractive index (n_{D}-C) of the entire component (C) and the refractive index (n_{D}-AB) of an entire matrix of components (A) and (B) is below 0.01.

26. The process of claim 17, wherein the thermoplastic molding composition (F) comprises no more than 5% by weight of water, based on the entire composition of the thermoplastic molding composition (F).

27. A thermoplastic molding composition (F) produced by the process of claim 17.

28. The thermoplastic molding composition (F) of claim 27, wherein the thermoplastic molding composition (F) comprises no more than 5 ppm of monomeric butadiene, based on the entire composition of the thermoplastic molding composition (F).

29. A device for conducting the process of claim 17, comprising an extruder, which comprises at least one screw with an external diameter (D), an addition section (DA), at least one mixing section (M), at least one devolatilization zone (E), and a melt pump (SP) with an entry aperture,
wherein the devolatilization zone (E) has at least one devolatilization aperture (O) and the arrangement of the devolatilization zone (E) and the melt pump (SP) is such that the total length of the screw elements of a region of conveying (FS) between the at least one devolatilization aperture (O) of the devolatilization zone (E) and the entry aperture of the melt pump (SP) is less than five times the external diameter (D) of the screw.

30. The device of claim 29, wherein there is at least one melt filter (F) arranged after the melt pump (SP) in conveying direction and/or the melt pump (SP) has connection to a device for underwater pelletization procedure (UW).

31. The device of claim 29, wherein the extruder has two screws rotating in the same direction.

32. The device of claim 29, wherein the at least one melting section (S) and one mixing section (M) are combined in a section of the extruder.

33. The process of claim 21, wherein the melt-pelletization procedure is an underwater pelletization procedure (UW).
